(19) United States
(12) Patent Application Publication
(10) Pub. No.: US 2006/0256368 A1
(43) Pub. Date: Nov. 16, 2006

(54) Image forming apparatus

(75) Inventors: Yasuomi Mitsui, Toyokawa-shi (JP); Hirokazu Higashiuchi, Toyokawa-shi (JP); Naoto Sugaya, Toyokawa-shi (JP); Kentaro Nagatani, Toyokawa-shi (JP)

Correspondence Address: MORRISON & FOERSTER LLP, 1650 TYSONS BOULEVARD, SUITE 300, MCLEAN, VA, 22102, US

(73) Assignee: Konica Minolta Business Technologies, Inc., Tokyo (JP)

(21) Appl. No.: 11/235,184

(22) Filed: Sep. 27, 2005

(30) Foreign Application Priority Data
May 12, 2005 (JP) 2005-139742

(51) Int. Cl. G06F 3/12

(52) U.S. Cl. 358/1.15

(57) ABSTRACT

Provided is an image forming apparatus capable of selecting a user who requires information on the image forming apparatus to post the information to the user. An image forming apparatus capable of being connected to a network, includes: usage history recording unit recording a usage history of a user who has executed a job on the image forming apparatus; determining unit selecting a user to whom information on the image forming apparatus is posted based on a usage history recorded in the usage history recording unit; and posting unit posting information on the image forming apparatus to a user terminal of the selected user.

This application is based on Japanese Patent Application No. 2005-139742 filed in Japan on May 12, 2005, the contents of which are hereby incorporated by reference.

### BACKGROUND OF THE INVENTION

1. Field of the Invention

This invention relates to an image forming apparatus connectable to a network.

2. Description of the Related Art

In recent years, multifunctional peripherals (MFP) have been used, not stand alone but being connected to a network, by plural users. An installment site or an IP address has been in some case changed by a person in charge of network management, in which case the person in charge of network management notifies users of a change in installment site or the like of MFP. In some case, however, a user has not been aware of the change in installment site till a communication from the person in charge of network management reaches the user, in which case it is necessary for the user to find out the MFP when the user requires print output.

There has been conventionally known an image processing system that enables a user to recognize an installment site of an image forming apparatus by posting a massage from the image forming apparatus to the user, as shown in Japanese Patent Laid-open Publication No. 2003-330641.

In a case where all of users already registered is posted of a change in an installment site, which has been the case conventionally, unnecessary messages are posted even to users who have practically not used, which imposes a load on a mail server.

### SUMMARY OF THE INVENTION

It is an object of the invention to provide an image forming apparatus capable of selecting a user who requires information on the image forming apparatus to post the information to the user.

An image forming apparatus pertaining to the invention is an image forming apparatus capable of being connected to a network, includes:

usage history recording unit recording a usage history of a user who has executed a job on the image forming apparatus;

determining unit selecting a user to whom information on the image forming apparatus is posted based on a usage history recorded in the usage history recording unit; and

posting unit posting information on the image forming apparatus to a user terminal of the selected user.

The image forming apparatus may further include installment site change detecting unit detecting a change in installment site of the image forming apparatus. In this case, the posting unit, when the change in installment site is detected by the installment site change detecting unit, can post information on the image forming apparatus to a user terminal of the selected user.

The image forming apparatus may still further include address change detecting unit detecting a change in address of the image forming apparatus. In this case, the posting unit, when the change in address is detected by the address change detecting unit, can post information on the image forming apparatus to the selected user. Note that the address may be the address of an image forming apparatus on a network, for example an IP address or a mail address.

The image forming apparatus may yet further include timing unit setting a timing at which information on the image forming apparatus is posted. In this case, the posting unit can post information on the image forming apparatus to a user terminal of the selected user at the timing set by the timing unit.

Note that the determining unit may select a user who has executed a job within a given time from among users recorded in the usage history recording unit. The determining unit may select a user who has the number of times of usage within a given time more than a given number of times of usage from among users recorded in the usage history recording unit. The determining unit may select a user to whom information on the image forming apparatus has not been posted from among users recorded in the usage history recording unit. Alternatively, the determining unit may select users who have the same network address from among users recorded in the usage history recording unit.

Information on the image forming apparatus may be information on the installment site of the image forming apparatus and/or information on the address of the image forming apparatus.

A network system pertaining to the invention is a network system including an image forming apparatus connected by a network and a user terminal, wherein

the image forming apparatus includes:

usage history recording unit recording a usage history of a user who has executed a job on the image forming apparatus;

determining unit selecting a user to whom information on the image forming apparatus is posted based on a usage history recorded in the usage history recording unit; and

posting unit posting information on the image forming apparatus to a user terminal of the selected user, and

the user terminal includes:

receiving unit receiving a message from the image forming apparatus; and

displaying unit displaying the message.

The user terminal may further includes:

display/non-display selecting unit for receiving selection of whether or not the message is displayed; and

display mode determining unit for determining which of the display/non-display has been set.

The user terminal may still further includes:

posting condition selecting unit receiving selection of a posting condition; and

transmitting unit transmitting the posting condition that has been selected to the image forming apparatus.

A method for posting information on an image forming apparatus pertaining to the invention is a method posting information on the image forming apparatus to a user terminal through a network from the image forming apparatus, including:

recording a usage history of the image forming apparatus by a user;

determining whether or not information on the image forming apparatus has been changed;

selecting a user based on the usage history; and

posting information on the image forming apparatus to a user terminal of the selected user.

A method posting information on an image forming apparatus pertaining to the invention is a method posting information on the image forming apparatus to a user terminal through a network from the image forming apparatus, includes:

recording a usage history of the image forming apparatus by a user;

determining whether or not it is a set posting timing;

selecting a user based on the usage history; and

posting information on the image forming apparatus to a user terminal of the selected user.

Note that there is provided an information posting program which causes a computer to execute the method for posting the information. The information posting program may be stored in a computer-readable recording medium.

An image forming apparatus pertaining to the invention selects a user based on a usage history of the image forming apparatus and posts information on the image forming apparatus. Therefore, a user who requires information on the installment site of the image forming apparatus is selected and the necessary information can be posted to the selected user.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a schematic diagram showing a system including image forming apparatuses and user terminals connected to a network;

FIG. 2 is a block diagram showing a physical construction of an image forming apparatus pertaining to a first embodiment of the invention;

FIG. 3 is a block diagram showing a functional construction of an image forming apparatus pertaining to the first embodiment of the invention;

FIG. 4 is a block diagram showing another example of the functional construction of an image forming apparatus pertaining to the first embodiment of the invention;

FIG. 5 is a flowchart of a method for posting information on an image forming apparatus pertaining to the first embodiment of the invention;

FIG. 6 is a flowchart showing details of step S01 of the flowchart of FIG. 5;

FIG. 7 is a flowchart showing details of step S02 of the flowchart of FIG. 5;

FIG. 8 is a flowchart of another example of the method for posting information on an image forming apparatus pertaining to the first embodiment of the invention;

FIG. 9 is a flowchart showing details of step S32 of the flowchart of FIG. 8;

FIG. 10 is a flowchart showing details of step S03 of the flowchart of FIG. 5 and step S33 of the flowchart of FIG. 8;

FIG. 11 is a flowchart of a method for displaying a message in a case where the message is received at a user terminal;

FIG. 12 is a flowchart of another example of the method for displaying a message in a case where the message is received at a user terminal;

FIG. 13 is an example display screen in a case where a message is displayed at a user terminal;

FIG. 14 is a block diagram showing a functional construction of an image forming apparatus pertaining to a second embodiment of the invention;

FIG. 15 is a flowchart of a method for posting information on an image forming apparatus pertaining to the second embodiment of the invention;

FIG. 16 is a block diagram showing a functional construction of a user terminal pertaining to a third embodiment of the invention;

FIG. 17 is a flowchart of a method for displaying a message in a case where the message is received at a user terminal;

FIG. 18 is a flowchart of a method for receiving a posting condition transmitted from a user terminal in an image forming apparatus, in a method for posting information on the image forming apparatus pertaining to a third embodiment of the invention;

FIG. 19 is a flowchart of a method for posting information on an image forming apparatus pertaining to the third embodiment of the invention; and

FIG. 20 is a flowchart showing details of step S114 of FIG. 19.

### DESCRIPTION OF THE PREFERRED EMBODIMENTS

Hereinafter, description will be given of an image forming apparatus and a method for posting information of the image forming apparatus pertaining to embodiments of the invention with reference to the accompanying drawings. The substantially same components are denoted by the same reference numerals in the drawings.

### First Embodiment

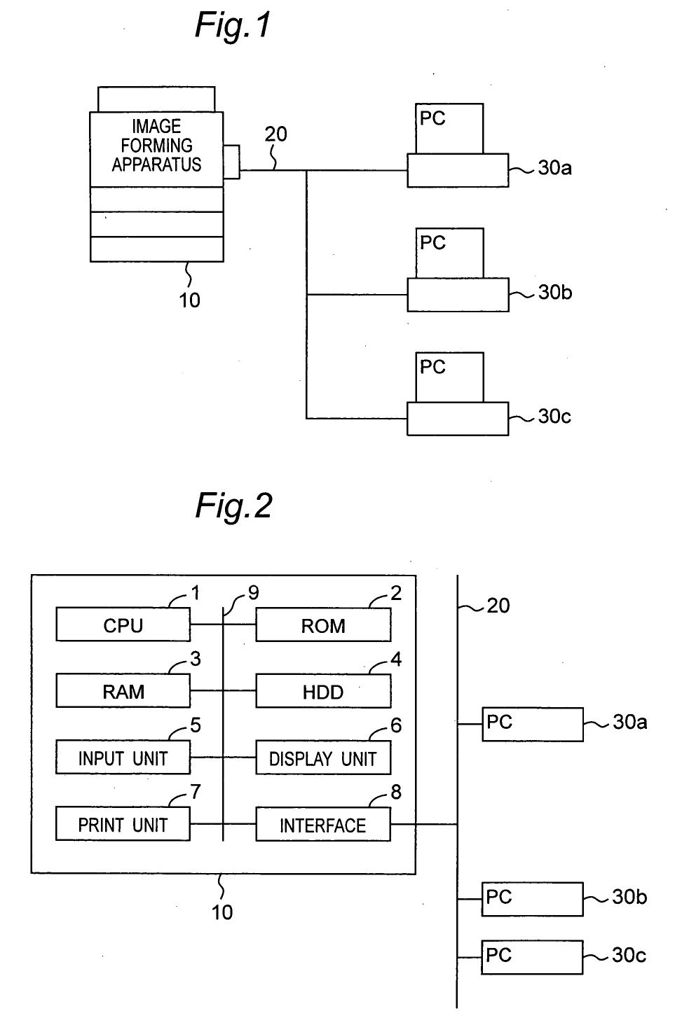

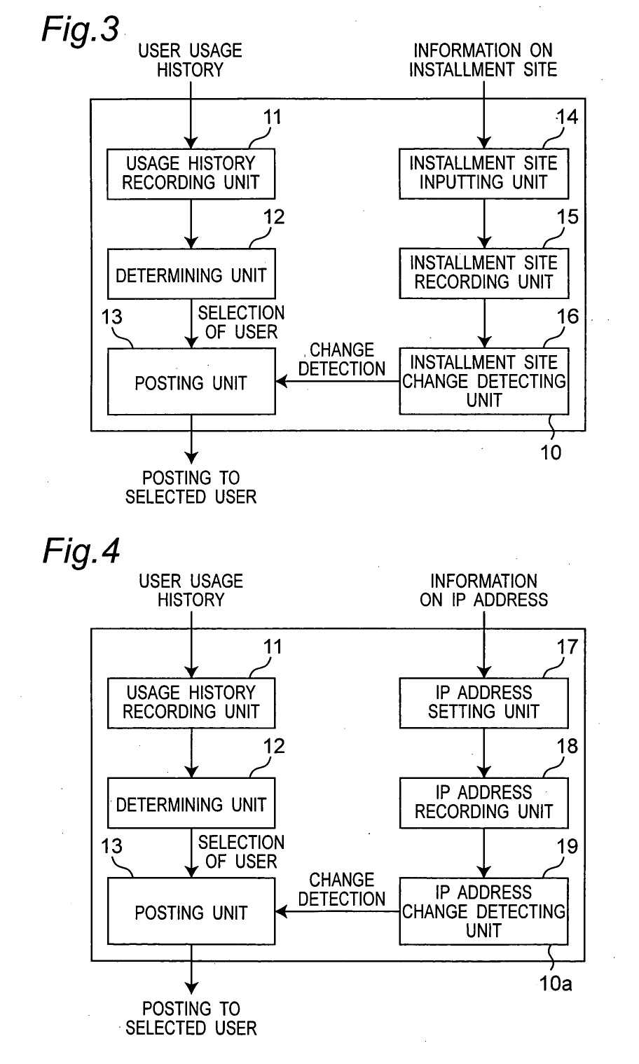

FIG. 1 is a schematic diagram showing a construction of a system including image forming apparatuses 10 pertaining to the first embodiment of the invention. The image forming apparatus 10 is connected to user terminals (PC) 30a, 30b and 30c through a network 20. FIG. 2 is a block diagram showing a physical construction of the image forming apparatus 10. The image forming apparatus 10 includes: a CPU 1; a ROM 2; a RAM 3, an HDD 4, an input unit 5, a display unit 6, a print unit 7; an interface 8 connectable to the network 20; and a bus 9. FIG. 3 is a block diagram showing a functional construction of the image forming apparatus 10. The image forming apparatus 10 includes: a usage history recording unit 11 recording a usage history of a user; a determining unit 12 selecting a user to whom information on the image forming apparatus 10 is posted based on a usage history of the user; a posting unit 13 posting information on the image forming apparatus to the user terminal 30a of the selected user; an installment site inputting unit 14 inputting information on the installment site of the image forming apparatus; an installment site recording unit 15 recording information on the installment site; and an installment site change detecting unit 16 detecting whether or not installment site has been changed. The image forming apparatus 10, in a case where the installment site of the image forming apparatus 10 has been changed, selects a user based on a usage history of the image forming apparatus 10 and posts information on the image forming apparatus, to be concrete the installment site of the image forming apparatus, to the selected user; therefore, information required by a user on the installment site of the image forming apparatus is posted to the user who requires the information. In this case, as described later, conditions for selecting a user from a usage history is changed, thereby enabling users who require posting of information to be further narrowed in number.

FIG. 4 is a block diagram showing another example of the functional construction of the image forming apparatus 10a. The image forming apparatus 10a is different from the image forming apparatus shown in FIG. 3 in that the image forming apparatus 10a includes: an IP address setting unit 17 inputting information on an IP address of the image forming apparatus 10a; an IP address recording unit 18 recording information on the IP address; and an IP address change detecting unit 19 detecting whether or not the IP address is changed, instead of the installment site inputting unit 14; the installment site recording unit 15 and the installment site change detecting unit 16. The image forming apparatus 10a, in a case where the IP address of the image forming apparatus 10a has been changed, selects a user based on a usage history of the image forming apparatus 10a and posts information on the image forming apparatus 10a, to be concrete the IP address of the image forming apparatus 10a; therefore, information required by a user on the IP address of the image formation apparatus 10a can be posted to the user who requires the information. Note that the image forming apparatus 10a, similar to the case of FIG. 3, may further include the installment site inputting unit 14; the installment site recording unit 15; and the installment site change detecting unit 16. In this case, when the installment site of the image forming apparatus or the IP address thereof has been changed, the changed information can be posted to a user selected from the usage history.

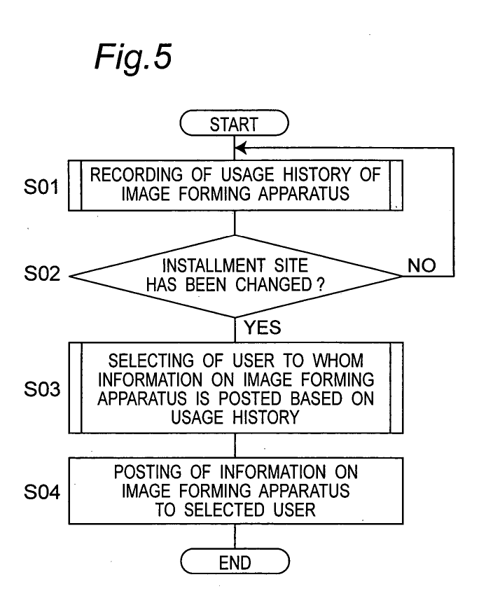

FIG. 5 is a flowchart of a method for posting information on the image forming apparatus 10 pertaining to the first embodiment of the invention.

(a) A usage history of the image forming apparatus 10 is recorded (S01). The step S01 will be described later.

(b) It is determined whether or not the installment site of the image forming apparatus 10 has been changed (S02). If the installment site has been changed, the process moves to the next step S03, if no installment site has been changed, the process returns to step S01 of recording a usage history.

(c) A user to whom information on the image forming apparatus 10 is posted is selected based on a usage history (S03). The step S03 will be described later.

(d) Information on the image forming apparatus 10 is posted to the user terminal 30a of the selected user (S04).

A method for posting information on the image forming apparatus 10, in a case where the installment site of the image forming apparatus 10 has been changed, selects a user based on a usage history of the image forming apparatus 10, and posts information on the image forming apparatus, to be concrete the installment site of the image forming apparatus, thereby enabling information on the installment site of the image forming apparatus required by a user to be posted to the user who requires the information.

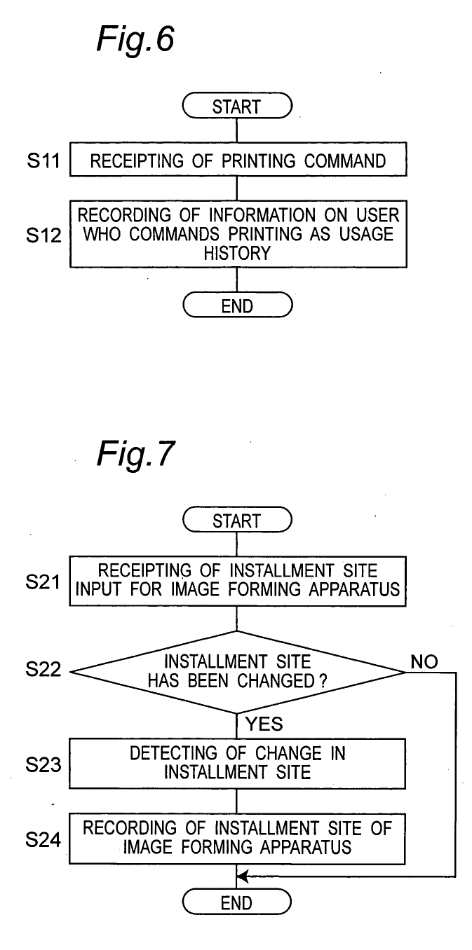

FIG. 6 is a flowchart showing details of step S01 of the flowchart of FIG. 5.

(a) A printing command has been received from the user terminal 30a (S11).

(b) Information on the user who commands the printing is recorded as a usage history (S12).

In the course of the steps, for example, a usage history as shown in Table 1 can be recorded. Table 1 is a list of a usage history of the image forming apparatus 10.

TABLE 1

| | | | | Data 4 |
|---|---|---|---|---|
| | Data 1 | Data 2 | Data 3 | Number |
| No. | Printing start date time | User name | Mail address | of prints |
| 1 | 2004.08.09 12:00 | Koizumi | koizumi@abcd.com | |
| 2 | 2004.08.09 19:00 | Tanaka | tanaka@abcd.com | |
| 3 | 2004.08.10 8:00 | Suzuki | suzuki@efgh.com | |
| 4 | 2004.08.10 8:30 | Suzuki, | suzuki@efgh.com | |
| 5 | 2004.8.11 9:00 | Koizumi | koizumi@abcd.com | |
| 6 | 204.08.11 14:00 | Koizumi | koizumi@abcd.com | |
| . . . | . . . | . . . | | |

Note that an example is shown here of a case where a usage history is recorded of a user who has issued a printing command, which is not limited to a case of a printing job, but a usage history may be recorded of each job of printing, scanning, facsimile transmission, and photo-copying, or alternatively, a usage history of all of jobs may simultaneously recorded.

The usage history of Table 1 may be recorded, after being compiled in a format useful for selection of a user, described later. For example, in Table 2, there is shown a user list in which the latest usage date time is recorded for each user from the usage history of Table 1.

TABLE 2

| | | | Change | |
|---|---|---|---|---|
| | | | information | |
| User | | Latest usage date | has been | |
| No. | User name | time | transmitted | Mail address |
| 1 | Tanaka | 2004.08.09 19:00 | 0 | tanaka@abcd.com |
| 2 | Suzuki | 2004.08.10 8:30 | 0 | suzuki@efgh.com |
| 3 | Koizumi | 2004.08.11 14:00 | 0 | koizumi@abcd.com |
| . . . | . . . | . . . | . . . | . . . |

FIG. 7 is a flowchart showing details of step S02 of the flowchart of FIG. 5.

(a) An input of the installment site of the image forming apparatus 10 is received (S21).

(b) The inputted installment site is compared with a recorded installment site and it is thereby determined whether or not a change has occurred (S22). If the change has occurred, the process moves to the next step S23, while if no change has occurred, the process is terminated.

(c) A change in installment site is detected (S23).

(d) The installment site of the image forming apparatus 10 is recorded (S24). In this case, the installment site that has been recorded is replaced with the inputted installment site.

In this flowchart, if a change in installment site is detected, “Y” is selected in FIG. 5 and the process moves to step S03, while if no change in installment site is detected, “N” is selected in FIG. 5 and step S01 is repeated.

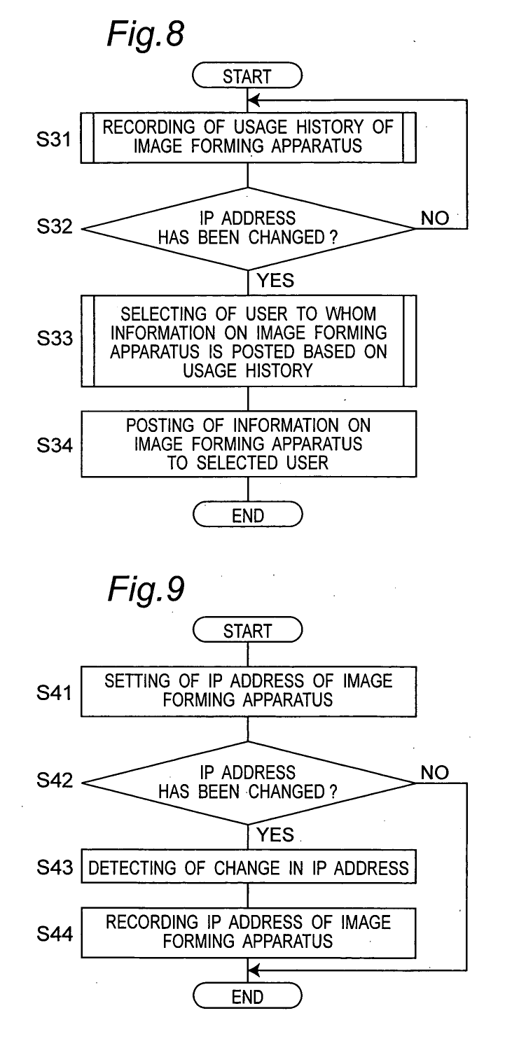

FIG. 8 is a flowchart of another example of the method for posting information on the image forming apparatus 10a.

(a) A usage history of the image forming apparatus 10a is recorded (S31). This step is the same as the step S01.

(b) It is determined whether or not the IP address of the image forming apparatus 10a has been changed (S32). If the IP address has been changed, the process moves to the next step S33, while if no IP address has been changed, the process returns to step S31 of recording a usage history.

(c) A user to whom information on the image forming apparatus 10a is posted is selected based on a usage history (S33). This step S33 will be described later.

(d) Information on the image forming apparatus 10a is posted to the user terminal 30a of the selected user (S34).

A method for posting information on the image forming apparatus 10a, in a case where the IP address of the image forming apparatus 10a has been changed, selects a user based on a usage history of the image forming apparatus 10a, and posts information on the image forming apparatus 10a, to be concrete the IP address of the image forming apparatus, thereby enabling information required by the user on the IP address of the image forming apparatus 10a to be posted to the user who requires the information.

FIG. 9 is a flowchart showing details of step S32 of the flowchart of FIG. 8.

(a) The IP address of the image forming apparatus 10a is set (S41).

(b) The IP address that has been set is compared with the recorded IP address and it is determined whether or not the IP address has been changed (S42). If the IP address has been changed, the process moves to the next step S43, while no IP address has been changed, the process is terminated.

(c) A change in the IP address of the image forming apparatus 10a is detected (S43).

(d) The IP address of the image forming apparatus 10a is recorded (S44). In this case, the IP address that has been recorded is rewritten with the set IP address.

In this flowchart, if a change in IP address is detected, “Y” is selected in FIG. 8 and the process moves to step S33, while if no change in IP address is detected, “N” is selected in FIG. 8 and the process repeats step S31.

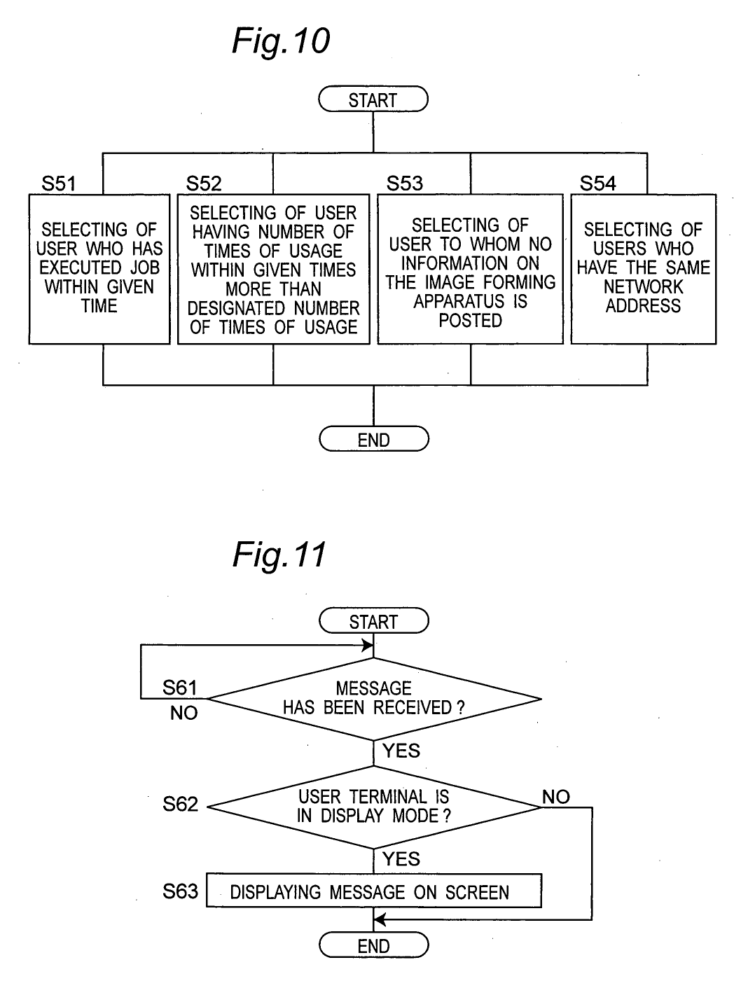

FIG. 10 is a flowchart showing details of step S03 of the flowchart of FIG. 5 and step S33 of the flowchart of FIG. 8. For example, the following four ways are presented as ones that select a user based on a usage history.

(a1) A user having executed a job within a given time is selected (S51). In the example of usage history shown in Table 1, two persons named Suzuki and Koizumi are selected under conditions of selecting a user who has used, for example, on and after Aug. 10, 2004.

(a2) A user having the number of times of usage within a given time more than a designated number of times of usage is selected (S52). In the example of usage history shown in Table 1, two persons named Suzuki and Koizumi are selected under conditions of selecting a user who has used on and after Aug. 9, 2004 two times or more as the number of times of usage.

(a3) A user to whom no information on the image forming apparatus 10 has been posted is selected (S53). In the example of usage history shown in Table 1, three persons named Tanaka, Suzuki and Koizumi are selected based on Table 2 after compilation.

(a4) Users who have the same network address are selected (S54). In the example of usage history shown in Table 1, two persons named Tanaka and Koizumi having, for example, a domain name (abcd.com) shared by both are selected based on the respective mail addresses.

Note that examples to which respective 4 conditions for selection are applied alone are taken, while no limitation is imposed on selection, and any of conditions for selection other than the conditions described above may be applied and besides, combination of plural conditions may be applied.

FIG. 11 is a flowchart of a method for displaying a message in a case where the message has been received at the user terminal 30a.

(a) It is determined whether or not the user terminal 30a has received a message from the image forming apparatus 10 (S61). If the message has been received, the process moves to the next step S62, while if no message has been received, the process repeats step S61.

(b) It is determined whether the user terminal 30a is in the display mode (S62). The terms “display mode/non-display mode” unit a setting of whether or not the user terminal 30a displays a message from the image forming apparatus 10. If the user terminal is in the display mode, the process moves to the next step S63, while if the user terminal is not in the display mode (the non-display mode), the process is terminated.

(c) The message that has been received is displayed on a screen (S63). The message that has been received is displayed on the screen, for example, as shown in FIG. 13.

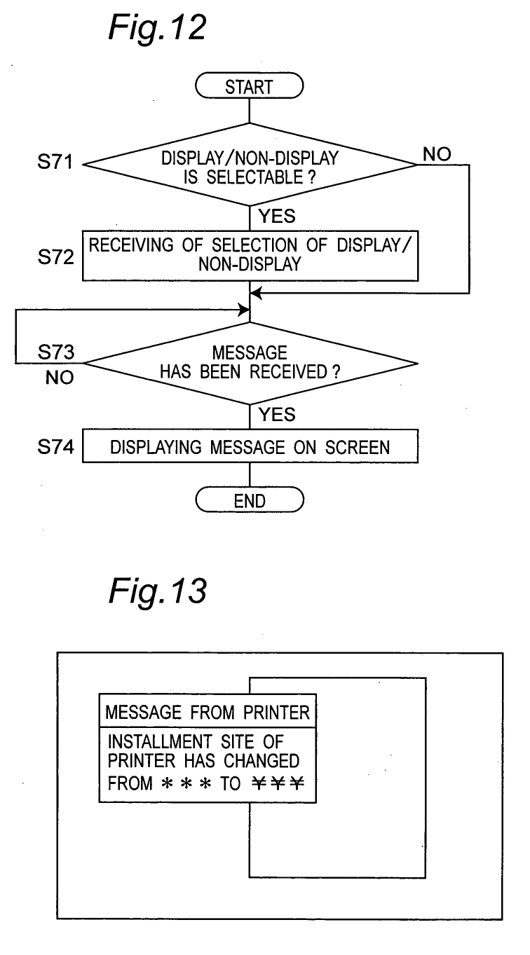

FIG. 12 is a flowchart of another example of the method for displaying a received message in a case where the message has been received at the user terminal 30a.

(a) It is determined whether or not display/non-display can be selected (S71). In the user terminal 30a, usually a mode of display on a screen in a case where a message of information on the image forming apparatus 10 has been received is set as default setting. Description, here, will be given of a case where a mode described above can be set individually at user terminals 30a. If a selection of display/non-display can be selected, the process moves to the next step S72. On the other hand, if no selection of display/non-display can be selected, a mode follows the default setting. Since the case here is a case of display, the process moves to step S73.

(b) A selection of display/non-display is received (S72).

(c) It is determined whether or not a message from the image forming apparatus 10 has been received (S73). If the message has been received, the process moves to the next step S74, while if no message has been received, step S73 is repeated.

(d) The message that has been received is displayed on a screen (S74). The message that has been received is displayed on a screen, for example, as shown in FIG. 13.

### Second Embodiment

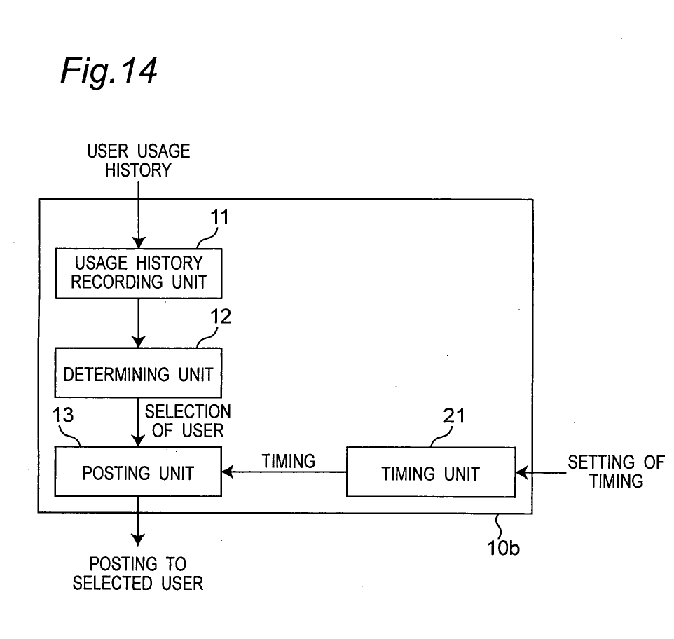

FIG. 14 is a block diagram showing a functional construction of an image forming apparatus 10b pertaining to a second embodiment of the invention. The image forming apparatus 10b is different from the image forming apparatus shown in FIG. 3 in that the image forming apparatus 10b includes: timing unit 21 setting a posting timing in addition to the installment site inputting unit 14, the installment site recording unit 15 and the installment site change detecting unit 16. Note that in FIG. 14, omitted in the figure are the installment site inputting unit 14, the installment site recording unit 15 and the installment site change detecting unit 16. The image forming apparatus 10b posts information on the selected image forming apparatus 10b, to be concrete information such as the installment site or the IP address of the image forming apparatus 10b, to the selected user at the set timing, for example at a designated time everyday. Thereby, the user can obtain information such as the installment site regularly. Note that the set timing is not limited to “a designated time everyday” but may be once a week, once a month or the like. A set timing is unnecessary to be regular.

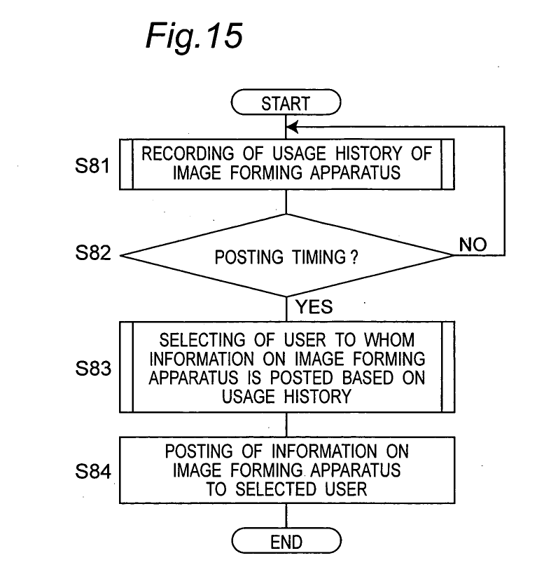

FIG. 15 is a flowchart of a method for posting information on the image forming apparatus 10b pertaining to the second embodiment of the invention.

(a) A usage history of the image forming apparatus 10b is recorded (S81). This step is the same as step S01.

(b) It is determined whether or not it is the set posting timing (S82). If it is the set timing, the process moves to the next step S83, while if it is not the set timing, the process returns to step S81 of recording a usage history.

(c) A user to whom information on the image forming apparatus 10b is posted is selected based on a usage history (S83). This step S83 will be described later.

(d) Information on the image forming apparatus 10b is posted to the selected user (S84).

A method for posting information on the image forming apparatus 10b can post information on the image forming apparatus 10b, to be concrete information such as the installment site or the IP address of the image forming apparatus 10b, to the selected user at the set timing, for example, at a designated time everyday. Thereby, the user can obtain information such as the installment site regularly.

### Third Embodiment

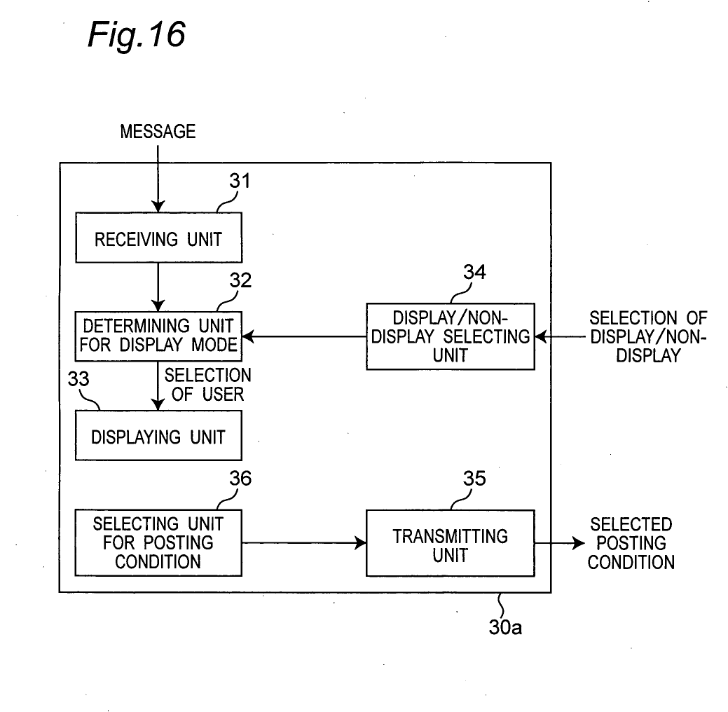

FIG. 16 is a block diagram showing a functional construction of the user terminal 30a pertaining to a third embodiment of the invention. The user terminal 30a includes: a receiving unit 31 receiving a message; a display/non-display selecting unit 34 receiving selection of display/non-display; a display mode determining unit 32 determining a display mode of display/non-display; a displaying unit 33 displaying a message; a posting condition selecting unit 36 receiving selection of a posting condition; and a transmitting unit 35 transmitting the selected posting condition to the image forming apparatus 10. The user terminal 30a can select display/non-display of the received message; therefore, enabling interruption of an operation due to display of the message to be prevented. Since a posting condition can be selected and transmitted to the image forming apparatus 10, information on the image forming apparatus 10 can be posted according to the desired posting condition.

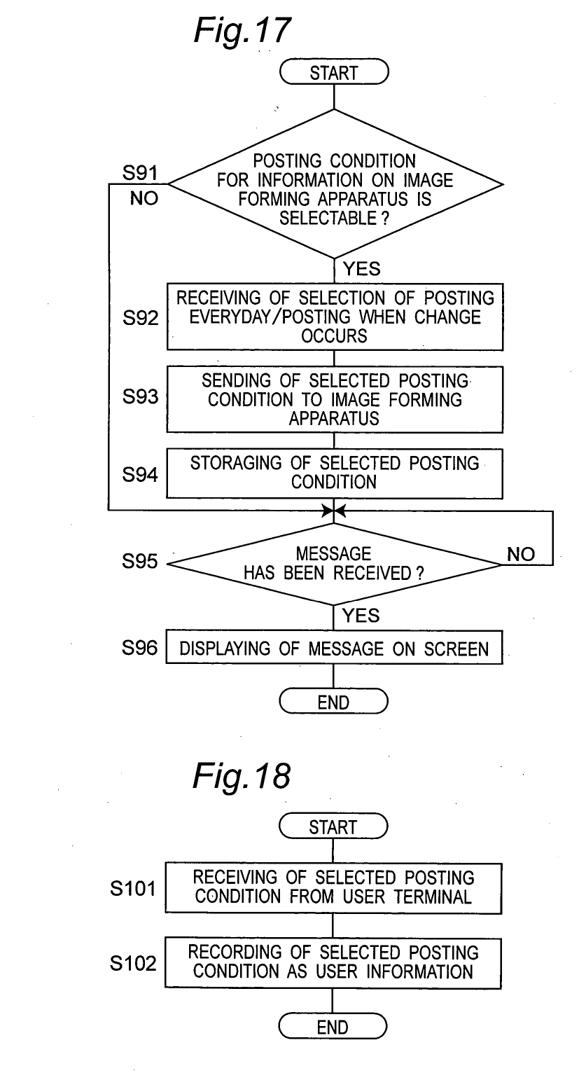

FIG. 17 is a flowchart of a method for displaying a message in a case where the message is received at the user terminal 30a. Default setting here is of a mode displaying a message.

(a) It is determined whether or not a posting condition for information on the image forming apparatus 10 can be selected (S91). If the condition can be selected, the process moves to the next step S92. If the condition cannot be selected, the process moves to step S95.

(b) Selection by a user of posting everyday/posting when a change occurs is received (S92). Only two conditions of “posting everyday” and “posting when a change occurs” are here considered as posting conditions, to which specific limitation is imposed but other posting conditions may be listed up and selected therefrom.

(c) The selected posting condition is sent to the image forming apparatus 10 (S93).

(d) The selected posting condition is stored (S94).

(e) It is determined whether or not a message from the image forming apparatus 10 has been received (S95). If no message has been received, the process repeats the same step S95. On the other hand, if a message has been received, the process moves to the next step S96.

(f) The received message is displayed on a screen (S96). The received message is displayed on a screen, for example, as shown in FIG. 13.

A method for posting information on an image forming apparatus pertaining to the third embodiment of the invention is different from the method for posting information pertaining to the first and second embodiments in that the information is posted according to the posting condition received from the user terminal. Thereby, posting of information on the image forming apparatus 10 can be received according to a posting condition that a user desires to have.

FIG. 18 is a flowchart of a method for receiving a posting condition transmitted from the user terminal 30a in an image forming apparatus 10, in a method for posting information on an image forming apparatus pertaining to the third embodiment of the invention.

(a) The selected posting condition is received from the user terminal 30a (S101).

(b) The selected posting condition is recorded as user information (S102). Note that the user information may be added to the user list using the image forming apparatus 10 of Table 2.

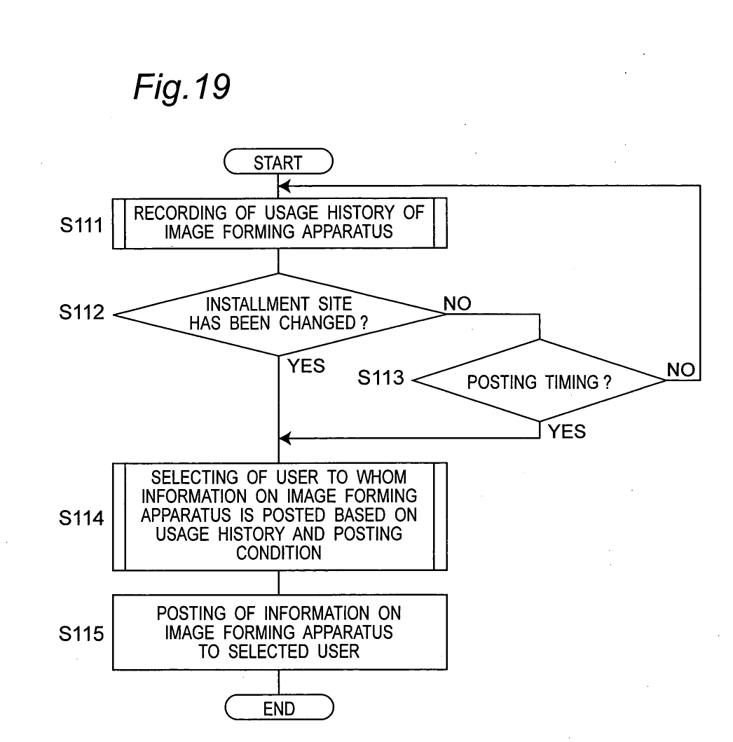

FIG. 19 is a flowchart of a method for posting information on the image forming apparatus 10 pertaining to the third embodiment of the invention.

(a) A usage history of the image forming apparatus 10 is recorded (S111). This step is the same as step S01.

(b) It is determined whether or not a change in installment site of the image forming apparatus 10 occurs (S112). This step is the same as step S02. If the installment site has been changed, the process moves to step S114. On the other hand, if the installment site has not been changed, the process moves to step S113.

(c) It is determined whether or not it is the set posting timing (S113). If it is the set posting timing, the process moves to the next step S114, while it is not the set posting timing, the process returns to step S111 of recording a usage history.

(d) A user to whom information on the image forming apparatus is posted is selected based on a usage history and a posting condition (S114). This step will be described later.

(e) Information on the image forming apparatus 10 is posted to the selected user (S115).

A method for posting information on the image forming apparatus 10 can post information on the image forming apparatus 10, to be concrete information such as the installment site or the IP address of the image forming apparatus 10 according a posting condition received from a user at a set timing, for example a designated time everyday, for example, when the installment site or the IP address has been changed. Thereby, a user can obtain information on the image forming apparatus, to be concrete information such as an installment site and an IP address based on the set posting condition.

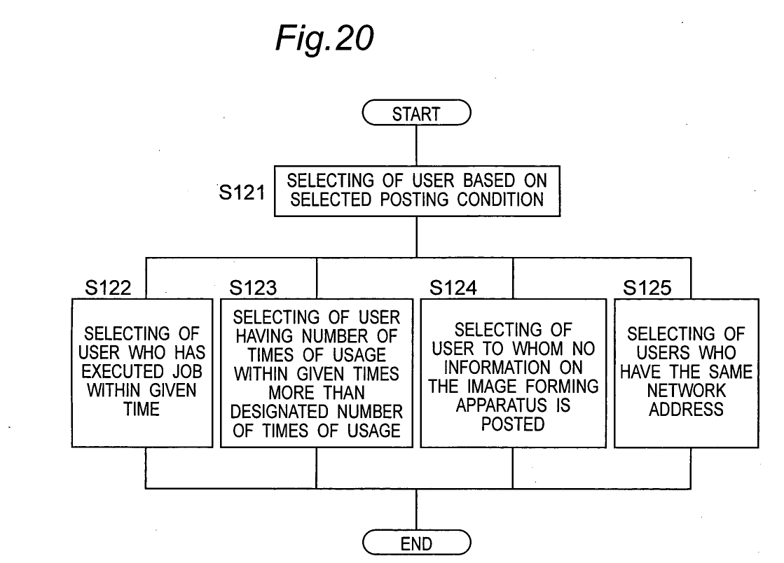

FIG. 20 is a flowchart showing details of step S114 of FIG. 19.

(a) A user is selected based on the selected posting condition (S121). A user who has selected, for example, “posting everyday” as a posting condition is selected as a user to whom posting is conducted at a timing of posting everyday. Alternatively, a user who has selected “posting when a change occurs” as a posting condition is selected as a user to whom posting is conducted when a change occurs.

(b1) A user who has executed a job within a given time is selected (S122). This step is the same as step S51.

(b2) A user who has the number of times of usage within a given time more than a given number of times of usage is selected (S123). This step is the same as step S52.

(b3) A user to whom no information on the image forming apparatus has been posted is selected (S124). This step is the same as step S53.

(b4) Users who have the same network address are selected (S125). This step is the same as step S54.

An image forming apparatus pertaining to the invention can be applied as an image forming apparatus capable of posting information on the image forming apparatus to a user terminal through a network.

Although the present invention has been described in connection with the preferred embodiments thereof with reference to the accompanying drawings, it is to be noted that various changes and modifications are apparent to those skilled in the art. Such changes and modifications are to be understood as included within the scope of the present invention as defined by the appended claims, unless they depart therefrom.

What is claimed is:

1. An image forming apparatus capable of being connected to a network, comprising:
usage history recording unit for recording a usage history of a user who has executed a job on the image forming apparatus;
determining unit for selecting a user to whom information on the image forming apparatus is posted based on a usage history recorded in the usage history recording unit; and
posting unit for posting information on the image forming apparatus to a user terminal of the selected user.

2. The image forming apparatus according to claim 1, further comprising: installment site change detecting unit for detecting a change in installment site of the image forming apparatus,
wherein the posting unit, when the change in installment site is detected by the installment site change detecting unit, posts information on the image forming apparatus to a user terminal of the selected user.

3. The image forming apparatus according to claim 1, further comprising: address change detecting unit for detecting a change in address of the image forming apparatus,
wherein the posting unit, when the change in address is detected by the address change detecting unit, posts information on the image forming apparatus to the selected user.

4. The image forming apparatus according to claim 1, further comprising: timing unit for setting a timing at which information on the image forming apparatus is posted,
wherein the posting unit posts information on the image forming apparatus to a user terminal of the selected user at the timing set by the timing unit.

5. The image forming apparatus according to claim 1, wherein the determining unit selects a user who has executed a job within a given time from among users recorded in the usage history recording unit.

6. The image forming apparatus according to claim 1, wherein the determining unit selects a user who has the number of times of usage within a given time more than a given number of times of usage from among users recorded in the usage history recording unit.

7. The image forming apparatus according to claim 1, wherein the determining unit selects a user to whom information on the image forming apparatus has not been posted from among users recorded in the usage history recording unit.

8. The image forming apparatus according to claim 1, wherein the determining unit selects users who have the same network address from among users recorded in the usage history recording unit.

9. The image forming apparatus according to claim 1, wherein information on the image forming apparatus is information on the installment site of the image forming apparatus.

10. The image forming apparatus according to claim 1, wherein information on the image forming apparatus is information on the address of the image forming apparatus.

11. The image forming apparatus according to claim 1, further comprising: installment site inputting unit for inputting information on the installment site of the image forming apparatus; and installment site recording unit recording information on the installment site of the image forming apparatus.

12. The image forming apparatus according to claim 1, further comprising: address setting unit for setting an address of the image forming apparatus; and address recording unit for recording the address of the image forming apparatus.

13. A network system including an image forming apparatus connected by a network and a user terminal, wherein
the image forming apparatus includes:
usage history recording unit for recording a usage history of a user who has executed a job on the image forming apparatus;
determining unit for selecting a user to whom information on the image forming apparatus is posted based on a usage history recorded in the usage history recording unit; and
posting unit for posting information on the image forming apparatus to a user terminal of the selected user, wherein
the user terminal includes:
receiving unit for receiving a message from the image forming apparatus; and
displaying unit for displaying the message.

14. The network system according to claim 13, wherein
the user terminal further includes:
display/non-display selecting unit for receiving selection of whether or not the message is displayed; and
display mode determining unit for determining which of the display/non-display has been set.

15. The network system according to claim 13, wherein
the user terminal further includes:
posting condition selecting unit for receiving selection of the posting condition; and
transmitting unit for transmitting the posting condition that has been selected to the image forming apparatus.

16. A method posting information on the image forming apparatus to a user terminal through a network from the image forming apparatus, comprising:
recording a usage history of the image forming apparatus by a user;
determining whether or not information on the image forming apparatus has been changed;
selecting a user based on the usage history; and
posting information on the image forming apparatus to a user terminal of the selected user.

17. The method posting information on an image forming apparatus according to claim 16, further comprising: determining whether or not it is a set posting timing.

18. An information posting program for causing a computer to execute a method posting the information according to claim 16.

19. A computer-readable recording medium storing the information posting program according to claim 18.
